(19) United States
(12) Patent Application Publication
(10) Pub. No.: US 2018/0323595 A1
(43) Pub. Date: Nov. 8, 2018

(54) NON-METALLIC FIBER CABLE HOISTING GRIP WITH CLOSED AND OPEN-MESH CONFIGURATION AND METHOD OF ASSEMBLY AND PLACEMENT

(71) Applicant: MIROC IMPORTS, LLC, Albuquerque, NM (US)

(72) Inventor: Brad Leigh, Albuquerque, NM (US)

(21) Appl. No.: 15/954,580

(22) Filed: Apr. 16, 2018

Related U.S. Application Data
(63) Continuation-in-part of application No. 15/589,125, filed on May 8, 2017, now abandoned.

(51) Int. Cl. H02G 7/06; H02G 1/04

(52) U.S. Cl. CPC H02G 7/06; H02G 1/04

(57) ABSTRACT

A cable hoisting grip comprising open- and closed mesh portions, the closed-mesh body embodiment comprising a lower end and an upper end extending into an eye portion, the ends comprising mesh openings. To hoist, a cable is inserted into the lower portion's opening through the mesh's body so that it extends through it. The open-mesh body embodiment comprises mirror-image lateral ends. To hoist, a cable is placed between the open-mesh body portions' lateral ends so that the mesh can envelope it. A lace is weaved into the open-mesh body lateral openings and secured by knotting each end closing the mesh. A lifting means is attached to the eye, as the hoisting grip rises, the weight of the cable elongates the mesh portion and decreases its diameter securing the cable via radial pressure. the hoisting grip is attached to the lifted and tower-positioned cable so that it permanently supports the cable.

### CROSS-REFERENCE TO RELATED APPLICATIONS

Non-applicable

### STATEMENT REGARDING FEDERALLY SPONSORED RESEARCH AND DEVELOPMENT

Non-applicable

### THE NAMES OF THE PARTIES TO A JOINT RESEARCH AGREEMENT

Non-applicable

### INCORPORATION-BY-REFERENCE OF MATERIAL SUBMITTED ON A COMPACT DISC

Non-applicable

### BACKGROUND OF THE INVENTION

### Field of the Invention

The present invention generally relates to devices used in the construction, maintenance and repair of telecommunication towers, more particularly, the present invention relates to a device used to position, place, hoist and support coaxial cable, fiber optic cable and electrical wire on utility poles and during and upon completion of the construction of telecommunications' towers.

### Description of the Related Art Including Information Disclosed Under 37 CFR 1.97 and 37 CFR 1.98

The following description of the art related to the present invention refers to a number of publications and references. Discussion of such publications herein is given to provide a more complete background of the principles related to the present invention and is not to be construed as an admission that such publications are necessarily prior art for patentability determination purposes. Various apparatuses, devices and systems comprising hoisting support grips are used in the utilities and telecommunications industries to hoist coaxial cable, fiber optic cable and electrical wire onto telecommunications' towers during the construction phase. Commonly, once the coaxial cable, fiber optic cable and/or electrical wire is installed in the utility pole or telecommunications' tower, the hoisting grips are attached to the tower structure and left in place as a support mechanism for the cable and/or wire.

The hoisting grips of the prior art are: (1) manufactured from either a tinned bronze or stainless steel wire; and (2) only known comprising a closed-mesh body configuration. When multiple runs of cable are in close proximity, which is very common, the hoisting grips' metallic material is known to cause passive intermodulation (PIM) Interference.

PIM is the nonlinear mixing of two or more frequencies in a passive circuit, which usually occurs when two or more signals are present in a passive non-linear device or element. The signals will mix with each other or multiply to generate other signals that are related to, but not the same as, the first ones.

Hoisting grips made out of Ferromagnetic materials, including ferrites, nickel and nickel-plated materials and steels, including some stainless steels are believed to cause PIM. That premise is based on the fact that those materials exhibit magnetic hysteresis effects when energy is applied which is believed to contribute to causing PIM. The known hoisting grips of the prior art are manufactured from metallic materials including some of the metallic ones listed above.

Further, all prior art hoisting grips comprise a closed-mesh body configuration, which presents several disadvantages, in that it: (1) is not easy to pack and ship, especially when the package contains multiple devices; (2) limits the user's ability to place the hoisting grip anywhere along the cable being hoisted without having to insert the hoisting grip at one end of the cable and slide it into position, which sometimes can involve tens or hundreds of feet; and (3) limits the user's ability to adjust the hoisting grip to the thickness of the cable(s) and adaptor(s) being hoisted.

A hoisting grip comprising an open-mesh body configuration and a closing lace would: (1) be easier, more convenient and less expensive to pack and ship because it would lay flat inside the packing container; (2) allow the user to place it in an open position at the most desirable point within the cable for optimum placement of the hoisting grip, hoisting and support of a cable(s), support of the cable(s) and attachment to a utility pole or telecommunications' tower, thus avoiding having to insert the cable into the closed-mesh and slide the hoisting grip in place; and (3) be adaptable to any thickness of cable(s) and cable/adaptor combinations because the user would manually envelope and lace the open-mesh body in place at the exact, ideal point of support and attachment to the pole or tower structure.

### BRIEF SUMMARY OF THE INVENTION

Objects, advantages and novel features, and further scope of applicability of the present invention will be set forth in part in the detailed description to follow, taken in conjunction with the accompanying drawings. The objects, advantages and novel features, and further scope of applicability of the present invention will become apparent to those skilled in the art upon examination of the following, or may be learned by practice of the invention. The objects and advantages of the invention may be realized and attained by means of the instrumentalities and combinations particularly pointed out in the appended claims.

The prior art does not disclose hoisting grips manufactured from non-metallic materials for two reasons: (1) non-metallic materials have been historically viewed as not suitable to hoist heavy cables due to lack of strength and insufficient gripping power; and (2) the obvious non-metallic choices (fiber/nylon) might produce undesirable ultra violet lack of resistance. The present invention is manufactured using non-metallic materials.

Moreover, the prior art does not disclose hoisting grips comprising an open-mesh body configuration which can be placed and closed at the exact point within the cable necessary to provide the most effective placement, cable support and engagement to the utility pole or telecommunications' tower structure without losing its gripping properties.

In the preferred embodiment of the invention, applicants used commercially available Aramid (aromatic polyamide) Fiber coated with a layer of Black Polyurethane 8 to 10 mils (0.203 mm to 0.254 mm) thick coating. The Black Polyurethane coating: (1) provides Ultra Violet protection to the Aramid Fiber; (2) smoothes out the Aramid Fiber thus helping to prevent catching or snagging of the hoisting grip on due to otherwise sharp edges; and (3) prevents the Aramid Fiber from collecting moisture between the fibers. The resulting composition provides the desired and required strength and is highly resistant to Ultra Violet rays.

The materials used to manufacture the present invention therefore overcome the prior art's problems by being roughly 85% the strength of steel. That strength more than suffices for the gripping and hoisting purposes of the present invention. Further, the invention embodied in the present application uses a material that provides the desirable ultra violet resistance.

One important advantage of the hoisting grip of the present invention is that it eliminates PIM known to occur when using metallic hoisting grips. When occurring nearby a telecommunications' tower, such as a cell phone tower, PIM can produce signal interference. That interference can sometimes hide or affect the purity of the desired signal. Accordingly, it is often necessary to try to remove any and all identifiable element(s) that generates the PIM so that interference generated can be removed. The fiber cable hoisting grip of the present invention, due to the material used to manufacture it, eliminates any PIM interference known to be caused by metal hoisting grips when used in connection with telecommunications' towers.

Another advantage of the hoisting grip of the present invention is that due to the material with which is manufactured, it provides more effective and stronger grip onto the cable it supports when compared with the metallic hoisting grips of the prior art. Final adjustments to the hoisting grips position on the cable are often made after the hoisting grip is attached to the structure. That is done by manually lifting the cable thus taking the cable weight or strain off of the hoisting grip. Once the cable is in position, the cable is lowered into the hoisting grip. Due to the stiffness of the bronze or stainless steel, the cable will slip some before the hoisting grips starts to elongate and compress around the cable. The fiber hoisting grips of the present invention are less stiff and more flexible. They elongate and compress around the cable immediately once the load is applied thus providing a stronger, more effective, more efficient and more secure grip effect.

Another distinct advantage brought about by the increase flexibility of the hoisting grip of the present invention is that it is easier to pack, takes less space in its packing and therefore packing and shipping are facilitated. In short, more units fit in less space.

Even another advantage presented by using fiber instead of metal is the overall weight of the device. That makes the shipping cheaper therefore reducing the overall cost of the device itself. The hoisting grip of the present application comprises a mesh portion, the mesh portion comprising a lower end, a body and an upper end. The lower end and the upper end both comprise mesh openings. The upper end of the mesh portion continuously extends into an eye portion.

The alternative embodiment of the invention comprising an open-mesh body configuration and a closing lace component made out of the same material and specifications as the grip itself presents several distinct advantages. Those advantages include, but are not limited to: (1) ease of packing and shipping which might result in lower shipping costs, especially when the package contains multiple devices; (2) allowing the user to place the hoisting grip anywhere along the cable being hoisted without having to insert the hoisting grip at one end of the cable and slide it into position, which sometimes can involve tens or hundreds of feet; and (3) allowing the user to adjust the hoisting grip to the thickness of the cable(s) and adaptor(s) being hoisted.

To provide the hoisting effect, the cable is inserted into the opening of the lower portion of the closed-mesh body embodiment, through the body of the mesh so that it extends through the opening of the upper portion of the mesh. In the embodiment of the invention comprising an open-mesh body and a closing lace, the mesh is positioned on the desired position within the cable and around it and laced in that position. A lifting means is attached to the eye so that as the hoisting grip rises, the weight of the cable causes the mesh portion of the grip to elongate. As the mesh portion elongates, because of its mesh configuration, its diameter decreases thus causing radial pressure on the cable. The radial pressure prevents the cable from sliding down in the hoisting grip.

Once the cable is positioned on the tower structure the hoisting grip is attached to the structure, permanently supporting the cable.

### BRIEF DESCRIPTION OF THE DRAWINGS

The embodiments of the present invention will be further described in detail hereinafter with reference to the drawings, wherein:

FIG. 1 is a frontal view of the invention of the present application showing all its elements.

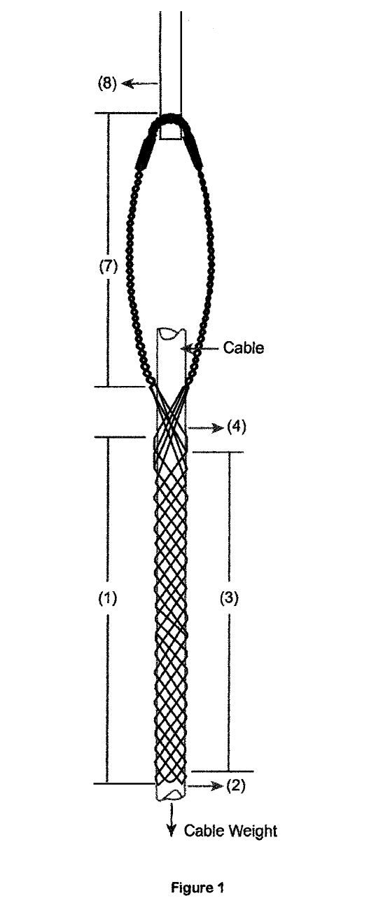

FIG. 2 is an exploded view of the lower end of the mesh portion of the present application in its “relaxed” mode showing the lower end opening.

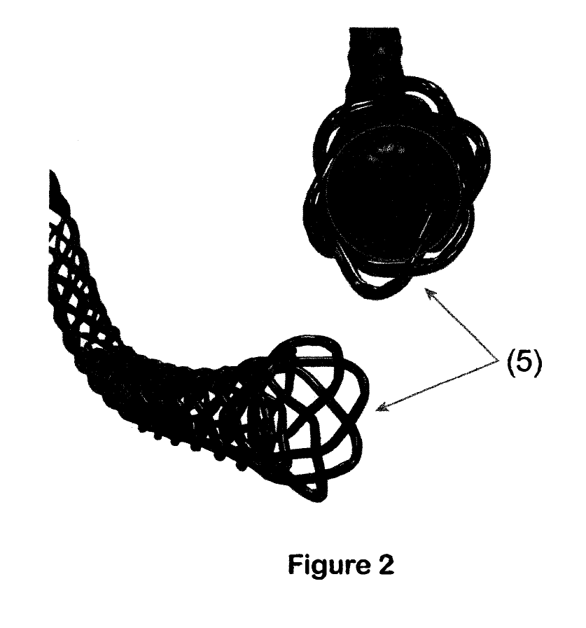

FIG. 3 is an exploded view of the lower end of the mesh portion of the present application in its “gripping” mode showing the end of a cable as it would engage to the lower end of the mesh portion while being lifted.

FIG. 4 is a perspective view of the invention of the present application in its “gripping” mode showing the end of a cable as it would engage to the lower end of the mesh portion while being lifted.

FIG. 5 is a frontal view of the elements of the embodiment of the invention of the present application shown while assembled around a cable, comprising a laced, open-mesh body configuration showing the mesh portion, the upper end of the mesh portion, the closing lace in place and the eye portion.

FIG. 6 is an exploded view of the embodiment of the invention of the present application comprising an open-mesh body configuration further showing the open-mesh body portion of the hoisting grip lying flat and placed on a cable without the closing lace being installed.

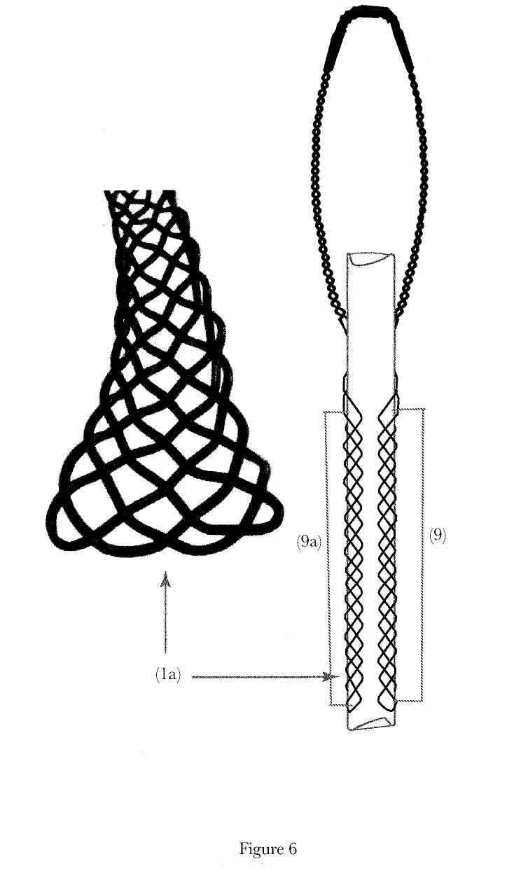

FIG. 7 shows is a frontal view of the embodiment of the invention of the present application comprising an open-mesh body configuration showing the open-mesh body portion of the hoisting grip enveloping a cable; one view further showing the closing lace being installed and another view showing the closing lace fully installed and knotted.

FIG. 8 shows a frontal view of the embodiment of the invention of the present application comprising an open-mesh body configuration further showing the gripping effect of the mesh over the cable created when the hoisting grip is lifted.

FIG. 9 shows the steps of the method of assembling and installing the open-mesh body embodiment of the invention comprising inserting the closing lace placed between the open-mesh body portions' lateral ends so that the cable can be enveloped by the mesh, inserting the closing lace into each of the openings located along the edges of the body open-mesh's lateral ends, weaving the closing lace into the openings and knotting each end of the lace resulting in a closed-mesh body configuration, fully installed hoisting grip.

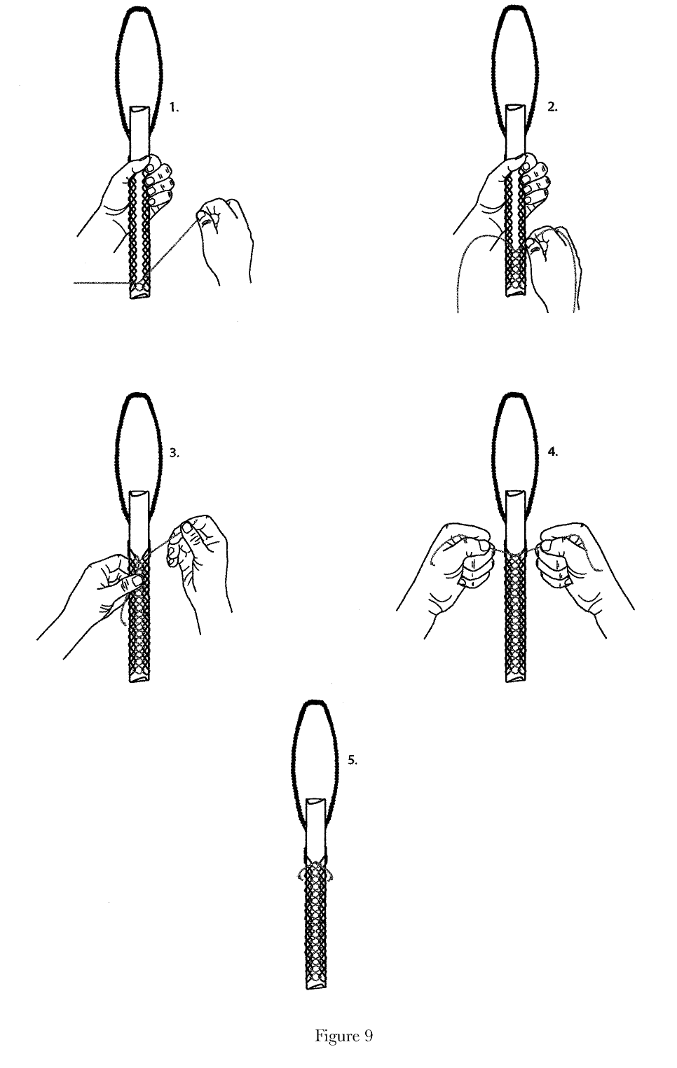

FIG. 10 shows a frontal view of the hoisting grip of the present invention with a cable placed in it and the combination grip/cable being attached to an electrical utility pole structure.

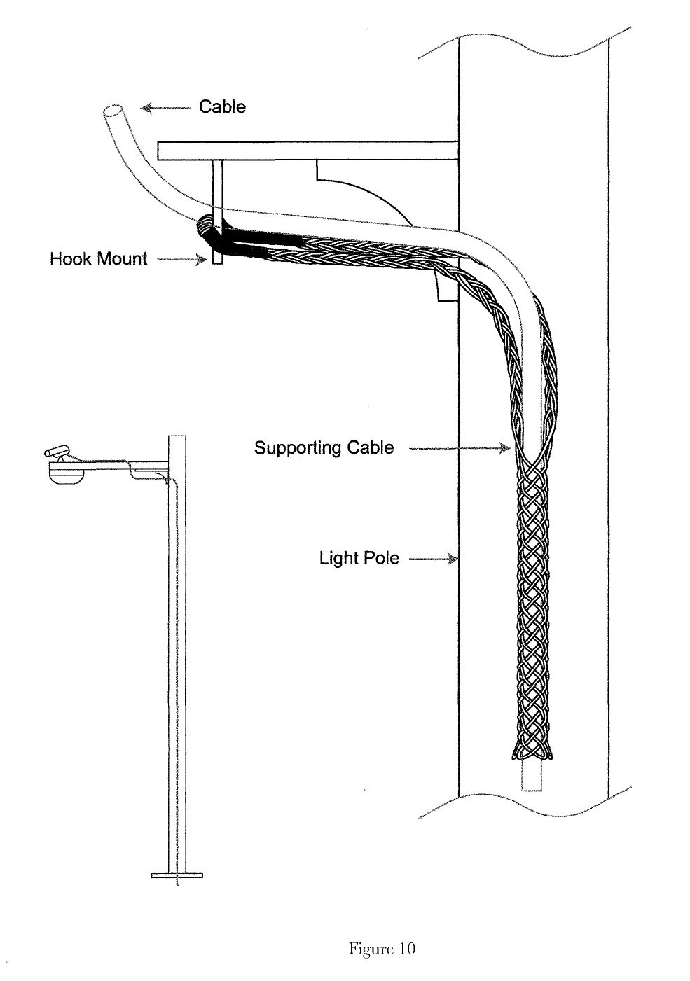

### DETAILED DESCRIPTION OF THE INVENTION

Objects, advantages and novel features, and further scope of applicability of the present invention will be set forth in part in the detailed description to follow, taken in conjunction with the accompanying drawings. The objects, advantages and novel features, and further scope of applicability of the present invention will become apparent to those skilled in the art upon examination of the following, or may be learned by practice of the invention. The objects and advantages of the invention may be realized and attained by means of the instrumentalities and combinations particularly pointed out in the appended claims.

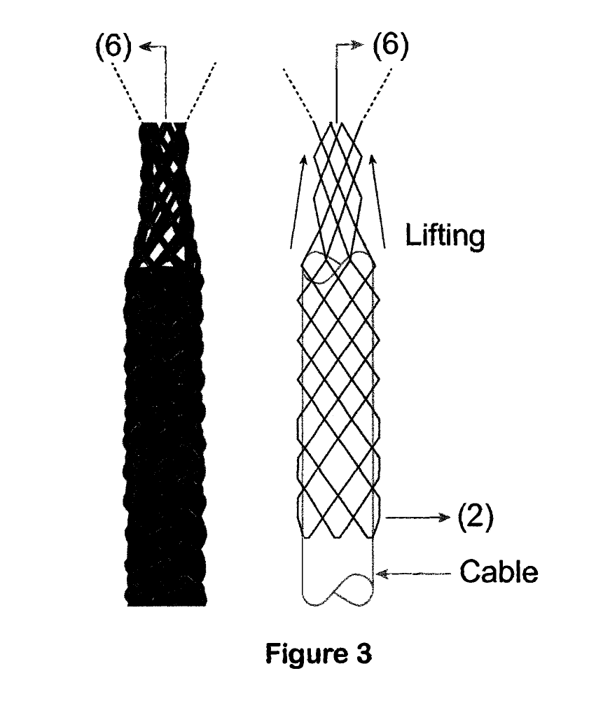

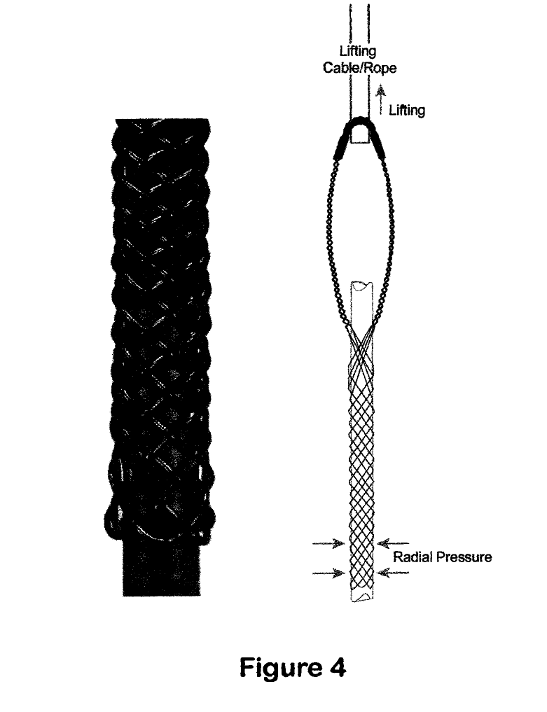

Specifically, the detailed description below refers to a cable hoisting grip comprising a mesh portion (1), the mesh portion comprising a lower end (2), a body (3) and an upper end (4). The lower end (2) and the upper end (4) both comprise mesh openings (5) and (6). The upper end (4) of the mesh portion (1) continuously extends into an eye portion (7). To provide the hoisting effect, a cable is inserted into the opening of the lower portion of the mesh (5), through the body of the mesh (3) so that it extends through the opening (6) of the upper portion of the mesh (4). A lifting means (8) is attached to the eye so that as the hoisting grip rises, the weight of the cable causes the mesh portion of the grip to elongate as shown and illustrated in FIGS. 3 and 4. As the mesh portion elongates, because of its mesh configuration, its diameter decreases thus causing radial pressure on the cable. The radial pressure prevents the cable from sliding down in the hoisting grip. Once the cable is lifted and positioned on the tower structure the hoisting grip is attached to the structure, permanently supporting the cable.

In the embodiment of the invention comprising an open-mesh mesh body portion (1a), the mesh portion comprises a body (3a) which comprises a lower end and an upper end and identical, mirror-image lateral ends (9) and (9a), with each lateral end comprising an edge and wherein each edge comprises multiple, adjacent mesh openings located and running along each edge of the lateral ends from each lower end and extending up to each upper end.

To provide the hoisting effect, a cable(s) is placed between the open-mesh body portions' lateral ends (9) and (9a) so that it can be firmly and tightly enveloped by the mesh. A closing lace (10) made of the same material and coating as the mesh portion, the closing lace comprising two end portions (11) and (11a) and a middle portion (12) is inserted and weaved and laced into each subsequent and opposing lateral side mesh opening located along the edges of the open-mesh body's lateral ends (9) and (9a), akin to the way shoe laces are weaved into shoe eyelets, resulting in a configuration whereupon the closing lace is weaved into the openings, the laces' middle portion (12) is located at and connects one end of each lateral side with the opposite and corresponding end of the other lateral side, and the laces' end portions (11) and (11a) are located exiting the last opening located at the upper end of each lateral side. The closing lace is then secured tightly in place by knotting each end resulting in a structure now comprising a closed-mesh body configuration.

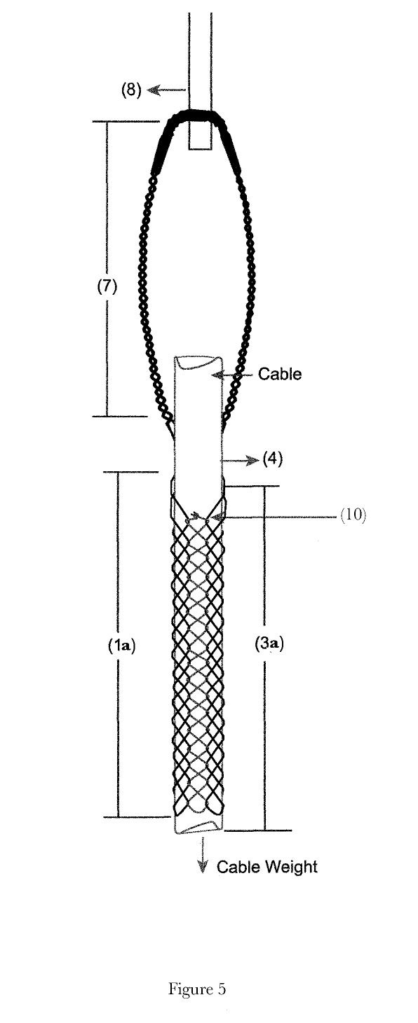

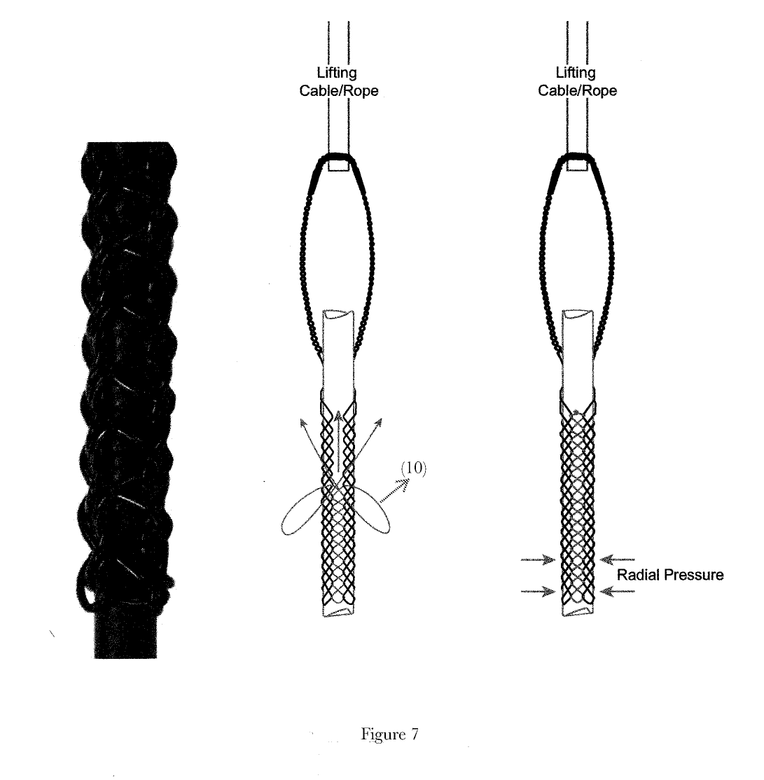

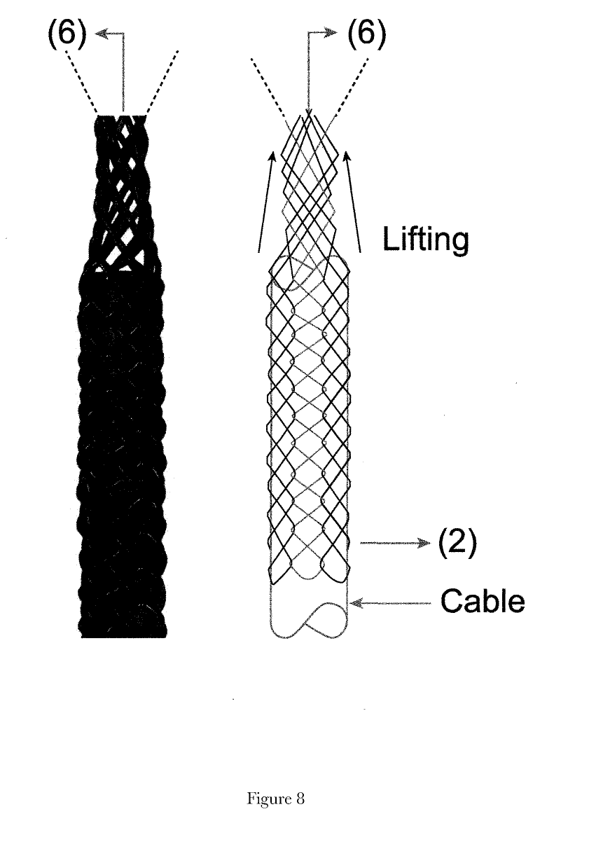

A lifting means (8) is attached to the eye (7) so that as the hoisting grip rises, the weight of the cable causes the mesh portion of the grip to elongate as shown and illustrated in FIGS. 5, 7 and 8. As the mesh portion elongates, because of its mesh configuration, its diameter decreases thus causing radial pressure on the cable. The radial pressure prevents the cable from sliding down in the hoisting grip. Once the cable is lifted and positioned on the tower structure the hoisting grip is attached to the structure, permanently supporting the cable.

What I claim is:

1. A cable hoisting grip device manufactured from a non-metallic material, the hoisting grip being used to hold, hoist, grip, elevate and maintain in place a cable or various sizes cables into utility poles and telecommunications' towers, the hoisting grip comprising:
a. a mesh portion;
b. the mesh portion comprising a body;
c. the mesh portion's body comprising a lower end and an upper end, both the lower end and the upper end of the mesh portion ending in mesh openings, with the upper end of the mesh portion continuously extending into an eye portion;
d. the eye portion forming a loop, the loop starting and ending on the upper end of the mesh portion; and
e. a lifting mechanism attached to the eye which together with the weight of the hoisting grip device and cable combination, allows the hoisting grip to be pulled upward.

2. The hoisting grip device of claim 1 wherein the mesh portion's body is cylindrically shaped and closed and wherein the body further comprises multiple mesh openings.

3. The hoisting grip device of claim 1 comprising a closing lace made of the same material and coating as the mesh portion and wherein the mesh portion's body is linearly open and the mesh portion's body further comprises a lower end and an upper end and identical, mirror-image lateral sides, with each lateral side comprising an edge and wherein each edge comprises multiple, adjacent mesh openings located and running along each edge of each lateral sides from each lower end and extending up to each upper end.

4. The hoisting grip device of claim 1 wherein it is manufactured from a highly resistant polyamide fiber comprising 85% minimum tensile capabilities when compared with steel and coated with a different polyurethane that provides Ultra Violet protection to the polyamide fiber, smoothes out the polyamide fiber thus helping to prevent catching or snagging of the hoisting grip due to otherwise sharp edges, and prevents the polyamide fiber from collecting moisture between the fibers.

5. The hoisting grip device of claim 1 wherein it is manufactured from a highly resistant polyamide fiber comprising 85% minimum tensile capabilities when compared with steel and coated with a different polyurethane wherein the polyamide fiber is the aromatic polyamide commercially known as Aramid fiber and the coating is the polyurethane commercially known as Black polyurethane and wherein the coating's thickness is between 8 and 10 mils or 0.203 mm to 0.254 mm.

6. A method to hold, hoist, grip, elevate and maintain in place a cable or various sizes cables into utility poles and telecommunications' towers using the closed-mesh body embodiment of the present invention, the method comprising the steps of:
a. providing the closed-mesh body embodiment of the present invention;
b. inserting a cable into the opening of the lower portion of the mesh, through the body of the mesh so that it extends through the body and protrudes through the opening of the upper portion of the mesh's body;
c. attaching a lifting means to the eye;
d. allowing the lifting means to pull up the hosting grip's eye portion so that as the hoisting grip rises, the pull combined with the weight of the cable causes the mesh portion of the grip to elongate;
e. allowing the mesh portion to elongate because of its mesh configuration so the mesh portion's diameter decreases thus causing radial pressure on the cable;
f. allowing the radial pressure on the cable to grip the cable and to prevent the cable from sliding down in the hoisting grip; and
g. attaching the hoisting grip to the utility pole or tower structure once the cable is positioned and permanently supported.

7. A method to hold, hoist, grip, elevate and maintain in place a cable or various sizes cables into utility poles and telecommunications' towers using the open-mesh body embodiment of the present invention, the method comprising the steps of:
a. providing the open-mesh body embodiment of the present invention;
b. placing at least one cable between the open-mesh body portions' lateral sides so that it can be enveloped by the open-mesh body portion;
c. firmly and tightly enveloping the cable with the open-mesh body portion of the hoisting grip;
d. inserting each end portion of the closing lace into a first opening of each lower portion of the mesh body's lateral sides;
e. lacing each end portion of the lace into each subsequent and opposite lower end of each lateral side mesh opening located along the edges of the open-mesh body's lateral sides akin to the way shoe laces are weaved and laced into shoes' eyelets, resulting in a configuration whereupon the lace is weaved and laced into the edge's openings, the laces' middle portion is located at and connects one end of each lateral side with the opposite and corresponding end of the other lateral side and the laces' end portions are located exiting at a last opening located at the upper end of each lateral side;
f. securing the closing the lace tightly in place at the upper portion of the lateral edges of the open-mesh body by knotting each end resulting in a structure now comprising a closed-mesh body configuration;
g. attaching a lifting means to the eye;
h. allowing the lifting means to pull up the hosting grip's eye portion so that as the hoisting grip rises, the pull combined with the weight of the cable causes the mesh portion of the grip to elongate;
i. allowing the mesh portion to elongate because of its mesh configuration so the mesh portion's diameter decreases thus causing radial pressure on the cable;
j. allowing the radial pressure on the cable to grip the cable and to prevent the cable from sliding down in the hoisting grip; and
k. attaching the hoisting grip to the utility pole or tower structure once the cable is positioned and permanently supported.
